(19) United States
(12) Patent Application Publication
(10) Pub. No.: US 2017/0105430 A1
(43) Pub. Date: Apr. 20, 2017

(54) Food product and method of making same

(71) Applicant: Josh Schreider, Oxnard, CA (US)

(72) Inventor: Josh Schreider, Oxnard, CA (US)

(21) Appl. No.: 14/756,805

(22) Filed: Oct. 16, 2015

(51) Int. Cl. A23C 19/00; A23C 19/14

(52) U.S. Cl. CPC A23L 1/0067; A23L 1/317; A23C 19/14; A23C 2250/10

(57) ABSTRACT

A gluten free and carbohydrate free food product comprised of a mixture of a ground meat and a ground cheese wherein the mixture is formed into a thin sheet like configuration and cooked and then cut into a desired geometrical configuration to provide a crust or layer or shell for a final or finished food product.

### FIELD OF THE INVENTION

This invention relates to the food art and more particularly to an improved food product which is gluten free and carbohydrate free and is formed in a sheet like configuration. The food product may be utilized in various geometrical shapes to provide a crust or shell configuration of a finished food and may also be utilized in a multi-layered stacked configuration to make a patty.

### DESCRIPTION OF THE PRIOR ART

The diet of many people is often restricted, either by medical advice or individual choice, to prevent the ingestion of various materials. One such diet restriction is often a gluten free diet to eliminate the ingestion of gluten containing foods. Another diet restriction is often a low or no carbohydrate diet. However, many commonly consumed products contain gluten and/or carbohydrates. Thus, such a person on such a restricted diet is prevented from ingesting conventional foods such as bread and other flour based products including pasta dishes, and other foods formed with a crust or shell made from flour thereby to eliminate gluten and/or carbohydrates from the diet. Such a diet, of course, eliminates conventional pasta dishes, bread, hamburgers and the like from such diets and reduces the quality of the life of people on such diets.

Thus, it has long been desired to find a substitute for the food products containing gluten and/or carbohydrates which may be incorporated into finished foods in the place of the gluten and/or carbohydrate containing products.

Accordingly, it is an object of the present invention to provide an improved food product useful in the manufacture of a plurality of finished foods.

It is another object of the present invention to provide an improved food product useful in the manufacture of a plurality of finished foods and in which the food product is gluten free.

It is another object of the present invention to provide an improved food product useful in the manufacture of a plurality of finished foods and in which the food product is gluten free and/or carbohydrate free.

### SUMMARY OF THE INVENTION

The above and other objects of the present invention are achieved, in a preferred embodiment, by providing a base member food product which may be utilized with other foods to ;provide a finished food product. The finished food product may be a crust or shell for finished food ;product such as pizza crust, lasagna sheet, ravioli shell, calzone shell, taco shell tortilla crust, burrito shell, egg roll shell, dumpling shell, pierogie shell, and pot pie crust, and the like. The base member food product of the present invention is comprised of a mixture of a ground meat and a ground cheese. The ground meat may be ground beef, ground poultry, ground turkey, ground goose, ground pheasant, or any other ground fowl or the like, or any combination thereof, and is ground to any desired consistency. The ground cheese may be ground parmesan, ground mozzarella or any other ground cheese alone or in any combination as may be desired for particular taste or application.

The ground meat and the ground cheese are mixed together to form a substantially uniform mixture and in a preferred embodiment of the present invention in a ratio of 25% cheese and 75% meat, though other ratios of ground meat to ground cheese may be utilized as desired to provide a particular taste for a particular application. Other seasonings, species or additives may be added to the uniform mixture as desired for imparting a particular flavor, texture or taste to the mixture.

The mixture having the ground meat and ground cheese is pressed in to a sheet which may be on the order of 1/4 inch to ⅛ in thickness, though other thicknesses may be selected as desired for a particular finished food product. The sheet of the mixture having the meat and cheese, and other ingredients that may be applied therein, is cooked at a temperature in the range of 300° F. To 485° F. For a time period in the range of 5 minutes to 15 minutes.

After the step of cooking, the sheet of cooked mixture may be cooled to a temperature in the range of ambient to frozen.

After cooling, the sheet of cooked mixture may be formed into a final geometric shape corresponding to the desired final food product. In many applications of the present invention cooked sheet may be utilized as a crust or shell for final food products such as pizza crust, lasagna sheet, ravioli shell, calzone shell, taco shell tortilla crust, burrito shell, egg roll shell, dumpling shell, pierogie shell, pot pie crust and similar final food products. Additionally, the cooked sheet may be formed into a conventional hamburger patty geometric shape and two or more of such the cooked sheet in the patty shaped configuration stacked together to make a final food product similar to a hamburger patty.

Alternatively, the cooked sheet may be cut into the desired shape for the final food product after cooking but before cooling of the cooked sheet to a temperature in the range of ambient to frozen.

### BRIEF DESCRIPTION OF THE DRAWING

The above and other embodiments of the present invention my be more fully understood from the following detailed description taken together with the accompanying drawing wherein similar reference characters refer to similar elements throughout and in which:

FIG. 1 is a block diagram illustrating the steps performed in the practice of the subject invention;

FIG. 2 is a semi-schematic representation of a ground meat according to the principles of the present invention;

FIG. 3 is a semi-schematic representation of a ground cheese according to the principles of the present invention;

FIG. 4 is a semi-schematic representation of a mixture of the ground meat and ground cheese according to the principles of the present invention; FIG. 5 is a semi-schematic isometric representation of a sheet of the mixture of the ground meat and ground cheese according to the principles of the present invention; and,

FIG. 6 is perspective view of a stack of the mixture of the cooked meat and cheese sheet formed into a generally rectangular patty configuration.

### DESCRIPTION OF THE PREFERRED EMBODIMENTS

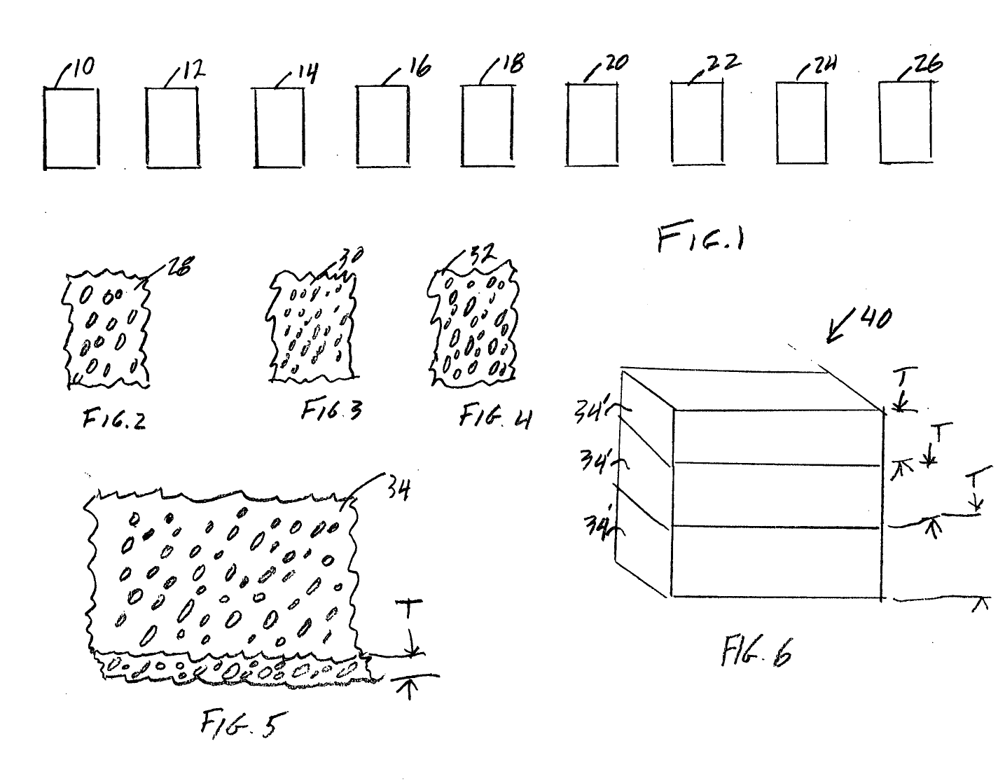

Referring now to the drawing, FIG. 1 is a block diagram illustrating the steps in the practice of the present invention. The first step 10 is the selection of a particular meat or mixture of meats to be included in the finished food product of the present invention. The meat or meats may be selected from for example one or meats such as beef, turkey, duck, chicken, goose, pheasant or any other desired fowl or appropriate meat. The second step 12 is the grinding of the meat selected in step 10 to form a ground meat portion. The ground meat portion may, for example, be of the consistency and texture of conventional ground meat utilized in hamburger patties The third step 14 is the selection of a cheese product to be used in the finished food product of the present invention. The cheese selected may be, for example, parmesan, mozzarella or any other desired cheese to provide a desired taste. The fourth step 16 is the grinding of the cheese selected in step 14 to form a ground cheese portion and the ground cheese portion may be of the consistency and texture of the conventional ground parmesan or ground mozzarella utilized in pasta dishes.

The fifth step 18 is the mixing of the ground meat portion of step 12 with the ground cheese portion of step 16 to form a ground mixture of the ground meat portion and the ground cheese portion. In the preferred embodiments of the present invention the ground meat portion of step 12 is in the range of 50% to 95% of the ground mixture and the ground cheese portion of step 16 is in the range of 5% to 50% of the ground mixture. The ground mixture of step 18 is a uniform mixture of the ground meat portion and the ground cheese portion By uniform mixture it is meant that each portion of the ground mixture contains about the same amount of the ground meat and the ground cheese.

The sixth step 20 is forming of the mixture into a base member of a sheet configuration having a thickness on the order of ⅛ of an inch to ⅜ of an inch though larger or smaller thicknesses may be utilized as desired for particular applications. The base member may be of any desired size compatible with the steps of the present invention as described herein. The seventh step 22 is cooking the sheet configuration of the base member formed in step 20. The cooking may be at a temperature in the range of 300° F. to 485° F. for a time period in the range of five minutes to fifteen minutes. Higher or lower cooking temperatures and/or longer or shorter cooking times may be selected as desired for particular applications. The eighth step 24 is cooling the cooked base member to an ambient temperature or, if desired a frozen temperature.

The final step 26 is cutting the cooked base member into a preselected configuration corresponding to the shape required for a final or finished food product. The final or finished food product may be, for example, pizza, lasagna sheet, ravioli, calzone, taco tortilla, burrito, egg roll l, dumpling l, pierogie , pot pie or the like and the cooked base member is cut into the geometrical configuration to provide the crust or layer or shell for the finished food product.

The step of cutting the cooked base member may be done before or after the cooked base member is cooled to ambient temperature or after the cooked base member is frozen as may b e desired for particular applications. Similarly, the steps of selecting a meat product, grinding the meat product, selecting a cheese product and grinding the cheese product may be performed in any desired order or sequence.

FIG. 2 is a semi-schematic representation of the ground meat portion indicated at 28 of the present invention after the step 12. The ground meat in the ground meat potion 28 is substantially evenly distributed throughout the mass of the ground meat portion. FIG. 3 is a semi-schematic representation of the ground cheese portion indicated at 30 of the present invention after the step 16. The ground cheese in the ground cheese portion 30 is substantially evenly distributed throughout the mass of the ground cheese.

FIG. 4 is a semi-schematic representation of the ground mixture indicated at 32 of the ground cheese portion 30 and ground meat portion 28 of the present invention after the step 18.

The ground mixture 32 is substantially uniform throughout the mass of the ground mixture 32 so that all parts of the ground mixture 32 contain substantially the same amount of the ground meat portion 28 and ground cheese portion 30.

FIG. 5 is a perspective view of a semi-schematic representation of the base member 34 formed into the sheet after the step 20. The thickness T may be on the order of ⅛ inch to ⅜ inch depending on the requirements for the final or finished food product.

FIG. 6 illustrates an other embodiment of the present invention generally indicated at 40 wherein the cooked base member after step 22 is formed into a generally rectangular patty configuration and three of such patties indicted at 34′ are stacked to make a final or finished food product to be enjoyed alone without forming into another food product.

Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

What is claimed is:

1. An improved food product comprising, in combination:
a base member;
said base member comprised of a mixture of ground meat and ground cheese and said base member formed in a sheet configuration having a preselected thickness, and said ground meat is at least one of ground beef, ground poultry or ground fowl and said cheese is at least one of parmesan and mozzarella;
said ground meat is on the order of 50% to 95% and said ground cheese is on the order of 5% to 50% of said base member;
said sheet of said base member cooked at a predetermined temperature in the range of 300° F. to 485° F. for a predetermined time period of 5 minutes to 15 minutes;
said cooked base member is formed into a configuration corresponding to the requirements for a preselected finished food product.

2. The arrangement defined in claim 1 wherein:
said cooked base member is cooled to ambient temperature before forming into a configuration corresponding to the requirements for a preselected finished food product.

3. The arrangement defined in claim 1 wherein:
said predetermined thickness of said base member prior to cooking thereof is in the range of ⅛ inches to ⅜ inches.

4. The arrangement defined in claim 1 wherein:
said base member is substantially uniform throughout.

5. The arrangement defined in claim 1 wherein:
said predetermined temperature is about 485 deg. F.

6. The arrangement defined in claim 1 wherein:
said predetermined time period is about five minutes;
said meat is one or a mixture of beef, turkey, duck, chicken, goose, pheasant or any other desired fowl or appropriate meat; and,
said cheese product is one or a mixture of parmesan, mozzarella or other appropriate cheese.

7. An improved food product comprising, in combination:
a base member comprised of a mixture of ground meat and ground cheese;
said ground meat is ground one or more of beef, turkey, duck, chicken, goose, pheasant or any other desired fowl;
said cheese is one or both of parmesan and mozzarella
said base member formed into a sheet;
said sheet of said base member cooked at a predetermined temperature for a predetermined time period.

8. The arrangement defined in claim 7 wherein:
said cooked sheet of said base member is cooled to a temperature between ambient temperature and frozen temperature.

9. The arrangement defined in claim 8 wherein:
said cooked sheet of said base member is formed into a final configuration of a preselected geometrical shape at a time period of one of before cooling to ambient temperature and after cooling to ambient temperature.

10. The arrangement defined in claim 9 wherein:
said final configuration is one of a pizza crust, lasagna sheet, ravioli shell, calzone shell, taco shell tortilla crust, burrito shell, egg roll shell, dumpling shell, pierogie shell, and pot pie crust.

11. The arrangement defined in claim 7 wherein:
said cooked sheet of said base member is formed into a patty shape comprised of a plurality of layers of said cooked sheet of said base member arranged in a stacked configuration.

12. The arrangement defined in claim 11 wherein:
said plurality of layers is in the ranged of two to five layers.

13. The arrangement defined in claim 7 wherein:
said predetermined time is in the range of 5 minutes to 15 minutes.

14. The arrangement defined in claim 7 wherein:
said predetermined temperature is in the range of 300 deg. F to 485 deg. F.

15. The arrangement defined in claim 14 wherein:
said predetermined time is in the range of 5 minutes to 15 minutes.

16. A method of making a food product comprising the steps of:
selecting a meat from the class consisting of beef, turkey, duck, chicken, goose, pheasant and fowl to form a meat portion;
grinding said meat portion into a ground meat portion having a predetermined ground meat consistency;
selecting a cheese from the class consisting of parmesan, mozzarella to form a cheese portion;
grinding said cheese portion into a ground cheese portion having a predetermined ground cheese consistency;
mixing said ground meat portion with said ground cheese portion to provide a substantially uniform base member ;
forming said uniform base member mixture into a sheet having a predetermined thickness;
cooking said sheet of uniform base member mixture of ground meat and ground cheese at a temperature in the range of 300 deg. F. to 485 deg. F. for a time period in the range of 5 minutes to 15 minutes to provide a cooked uniform sheet of a mixture of ground meat and ground cheese;

17. The method defined in claim 16 and further comprising the step of:
cooling said cooked uniform sheet of a mixture of ground meat and ground cheese to ambient temperature.

18. The method defined in claim 16 and further comprising the step of:
cutting said cooked uniform sheet of a mixture of ground meat and ground cheese into a preselected geometric configuration; and
cooling said geometric configuration of said cooked uniform sheet of a mixture of ground meat and ground cheese to ambient temperature.

19. The method defined in claim 16 and further comprising the step of:
cutting said cooked uniform sheet of a mixture of ground meat and ground cheese into a plurality of patty shaped discs; and,
stacking a plurality of said patty shaped discs onto each other.
